(19) United States
(12) Patent Application Publication
(10) Pub. No.: US 2010/0075667 A1
(43) Pub. Date: Mar. 25, 2010

(54) Apparatus, Method and Computer Program Product Providing Inter-Node B Signalling of Cell Status Information

(75) Inventors: Masatoshi Nakamata, Kanagawa (JP); Woonhee Hwang, Espoo (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/526,600

(22) PCT Filed: Feb. 12, 2008
(86) PCT No.: PCT/IB2008/050504

§ 371 Date: Nov. 16, 2009

(30) Foreign Application Priority Data
Feb. 12, 2007 (US) 60901700

(51) Int. Cl. H04W 4/00; H04W 72/00; H04W 36/00

(52) U.S. Cl. 455/432.3; 455/450; 455/436

(57) ABSTRACT

In an exemplary aspect of the invention there is a method comprising receiving cell-related information from a first access node at a second access node, and using the cell-related information during at least one of a handover and a radio resource control (RRC) related operation. Where the use of the exemplary embodiments of this invention include, but are not limited to, reducing handover execution time, reducing the signaling load related to an unsuccessful handover and/or radio resource control related procedures, and reducing the need of a user equipment to measure unnecessary cells.

### TECHNICAL FIELD

The exemplary and non-limiting embodiments of this invention relate generally to wireless communication systems, methods, devices and computer program products and, more specifically, relate to techniques related to cell or eNB operational mode and capability exchange.

### BACKGROUND

Various abbreviations that appear in the specification and/or in the drawing figures are defined as follows:

3GPP third generation partnership project

ARQ automatic repeat request

AS access stratum

AM acknowledge mode

CRC cyclic redundancy check

DL downlink

EUTRAN evolved UTRAN

eNB EUTRAN Node B

HARQ hybrid ARQ

HO handoff (handover)

UE user equipment

UTRAN universal terrestrial radio access network

UL uplink

LTE long term evolution

MAC medium access control

MBMS multimedia broadcast multicast service

MME mobility management entity

NAS non-access stratum

Node B base station

OFDM orthogonal frequency division multiplexing

PDCP packet data convergence protocol

PDU protocol data unit

RAT radio access technology

RB radio bearer

RRC radio resource control

RLC radio link control

SC-FDMA single carrier frequency division multiple access

SDU service data unit

SRB signaling radio bearer

TM transparent mode

UM un-acknowledge mode

UPE user plane entity

A proposed communication system known as evolved UTRAN (E-UTRAN, also referred to as UTRAN-LTE or as E-UTRA) is currently under discussion within the 3GPP. The assumption is that the DL access technique will be OFDM, and the UL access technique will be SC-FDMA using cyclic prefixes to achieve UL inter-user orthogonality.

Two publications of interest to the following discussion are 3GPP TS 36.300, V0.5.0 (2007-02), 3rd Generation Partnership Project, Technical Specification Group Radio Access Network, Evolved Universal Terrestrial Radio Access (E-UTRA) and Evolved Universal Terrestrial Radio Access Network (E-UTRAN) Overall description Stage 2 (Release 8), and 3GPP TR R3.018, V0.6.0 (2006-10), 3rd Generation Partnership Project, Technical Specification Group Radio Access Network, Evolved UTRA and UTRAN Radio Access Architecture and Interfaces (Release 7).

FIG. 1 reproduces FIG. 4 of 3GPP TS 36.300, and shows the overall EUTRAN architecture, where eNBs 12 communicate with MME/UPE entities 14 via an S1 interface 13, and communicate with one another via X2 interfaces 15.

FIG. 2 reproduces FIG. 10.1.2.1 of 3GPP TS 36.300, and shows the signal flow and entities involved in an intra-MME/UPE HO of a UE 10. FIG. 2 illustrates the signal flow in relation to the UE 10, a source which may be currently serving an eNB 12, a target eNB 12′, and the MME/UPE 14.

A problem that is presented during the HO scenario depicted in FIG. 2 is that the source eNB 12 does not have information regarding the availability and capability of cells under control of neighboring eNBs. As a result the source eNB 12 may send the target eNB 12′ a request to execute a HO of the UE 10 to the cell of a target eNB which, however, the target eNB 12′ is not able to accept for some reason. For example, the cell may not be available (e.g., due to a hardware failure or planned cell shutting down for certain time in a day), or may be unavailable for lack of support of some required feature needed by the UE 10 after the HO. In this case the source eNB 12 may expect to receive a failure message from the target eNB 12′.

As may be appreciated, this type of operation can delay the HO execution or fail the HO, and can also degrade performance due at least to an increase of potentially unnecessary signaling on the X2 interface.

### SUMMARY

In an exemplary aspect of the invention there is a method comprising receiving cell-related information from a first access node at a second access node, and using the cell-related information during at least one of a handover and a radio resource control (RRC) related operation.

In still another exemplary aspect of the invention there is an apparatus comprising an interface, a processor, the interface configured to receive cell-related information from a first access node, and the processor coupled to the interface configured to use the cell-related information during at least one of a handover and a radio resource control (RRC) related operation.

In yet another exemplary aspect of the invention there is an apparatus comprising means for receiving cell-related information from a first access node, and means for using the cell-related information during at least one of a handover and a radio resource control (RRC) related operation.

In the exemplary aspect of the invention above, it can be seen from the description of the invention that the means for sending comprises a transmitter and the means for using the cell-related information comprises a processor coupled to the transmitter.

In still another exemplary aspect of the invention, there is a method comprising determining cell-related information corresponding to a cell associated with a first access node, and sending the cell-related information to a second access node.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 reproduces FIG. 4 of 3GPP TS 36.300, and shows an overall EUTRAN architecture;

FIG. 2 reproduces FIG. 10.1.2.1 of 3GPP TS 36.300, and shows a signal flow and the entities involved in an intra-MME/UPE HO of a UE;

FIG. 3 illustrates a simplified block diagram of various electronic devices that are suitable for use in practicing the exemplary embodiments of this invention;

FIG. 4 reproduces FIG. 4.3.1 of 3GPP TS 36.300 and illustrates a user-plane protocol stack;

FIG. 5 reproduces FIG. 4.3.2 of 3GPP TS 36.300 and illustrates a control-plane protocol stack;

FIG. 6 reproduces FIG. 20.2 of 3GPP TS 36.300 and illustrates an X2 interface control plane;

FIG. 7 reproduces FIG. 20.2.2 of 3GPP TS 36.300 and shows in table form X2 control plane procedures;

FIG. 8 shows a logic flow diagram of a method in accordance with the exemplary embodiments of this invention;

FIG. 9 shows in a logic flow diagram another method in accordance with the exemplary embodiments of the invention; and

FIG. 10 illustrates in a logic flow diagram yet another method in accordance with the exemplary embodiments of the invention.

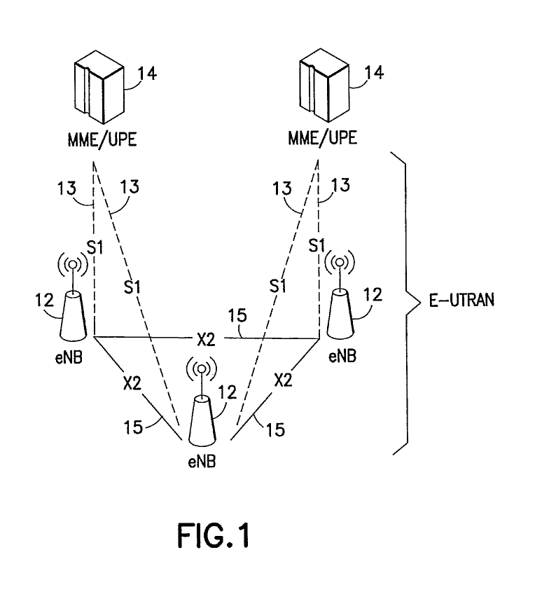

### DETAILED DESCRIPTION

The exemplary embodiments of this invention relate to 3GPP LTE radio access, and more specifically to signaling related to the inter-eNB X2 interface.

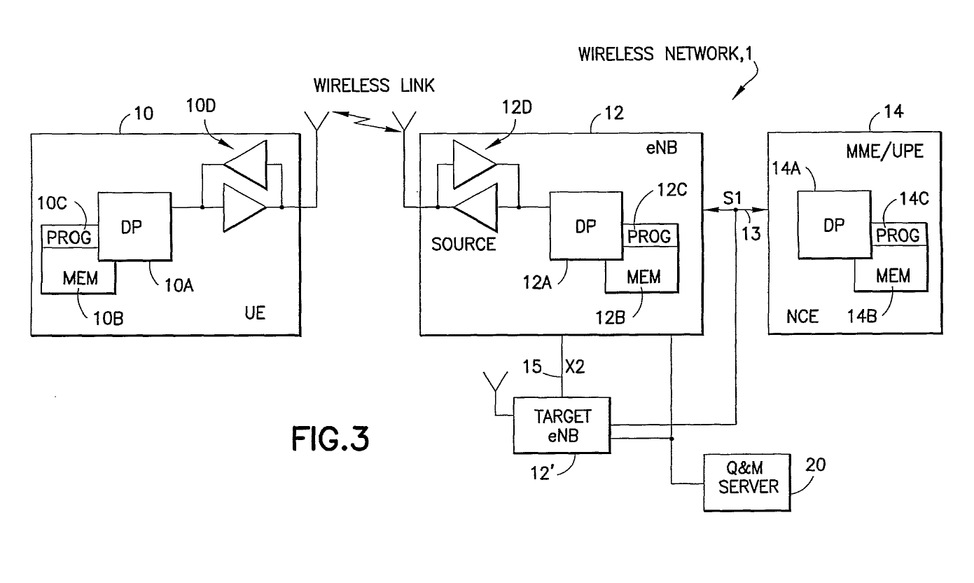

Reference is made to FIG. 3 for illustrating a simplified block diagram of various electronic devices that are suitable for use in practicing the exemplary embodiments of this invention. In FIG. 3 a wireless network 1 (assumed for this example to be an EUTRAN network) is adapted for communication with a UE 10 via an access node such as a Node B (base station) 12 (also referred to herein as eNB 12). The network 1 may include a network control element (NCE), which may represent or comprise the MME/UPE 14. The UE 10 includes a data processor (DP) 10A, a memory (MEM) 10B that stores a program (PROG) 10C, and a suitable radio frequency (RF) transceiver 10D for bidirectional wireless communications with the eNB 12, which also includes a DP 12A, a MEM 12B that stores a PROG 12C, and a suitable RF transceiver 12D. The eNB 12 is coupled via a data path, the S1 interface 13, to the MME/UPE 14, that also includes at least one DP 14A and MEM 14B storing an associated PROG 14C.

Shown for completeness in FIG. 3 is at least one second eNB referred to as 12′ (which may be considered to be a neighbor eNB). During a HO event the eNB 12 may be considered the source eNB, i.e., the eNB to which the UE 10 is currently connected and communicating in the associated serving cell, and the eNB 12′ may be considered the target eNB, i.e., the eNB to which the UE 10 may be connected and communicating with in the target cell after the HO procedure is completed. The eNB 12′ can be considered for this discussion to be constructed similarly to the eNB 12. The eNBs 12, 12′ are communicatively coupled together via the X2 interface 15.

At least the eNB PROGs 12C are assumed to include program instructions that, when executed by the associated DP, enable the electronic device to operate in accordance with the exemplary embodiments of this invention, as will be discussed below in greater detail.

That is, the exemplary embodiments of this invention may be implemented at least in part by computer software executable by the DP 12A of the eNBs 12, 12′, or by hardware, or by a combination of software and hardware.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 10B, 12B and 14B may be of any type suitable to the local technical environment and may be implemented using any suitable data storage technology, such as semiconductor-based memory devices, magnetic memory devices and systems, optical memory devices and systems, fixed memory and removable memory. The DPs 10A, 12A and 14A may be of any type suitable to the local technical environment, and may include one or more of general purpose computers, special purpose computers, microprocessors, digital signal processors (DSPs) and processors based on a multi-core processor architecture, as non-limiting examples.

In accordance with the exemplary embodiments of this invention the eNBs 12, 12′ exchange cell-related information over the X2 interface 15. The cell-related information can include information regarding the cell's availability, its capability to support one or more features and, in general, any information that may potentially influence a determination of an appropriate target eNB by the source eNB during a HO event.

Further in accordance with the exemplary embodiments of the invention the eNB 12, 12′ accumulate or determine information pertaining to one or more cells that are controlled by the eNB 12, 12′, respectively. This information may be used in creating the cell-related information that is exchanged.

Note that the exchanged information may be only for cells which are neighboring to a cell controlled by the neighboring eNB. That is, if one assumes that there are X cells controlled by a particular eNB, the exchanged information may pertain to possibly only one of the X cells that happens to be a neighbor cell to cells controlled by another eNB.

The signaling load on the X2 interface 15 due to operation of the exemplary embodiments of this invention may be modest, and the cell-related information may be sent based on an occurrence of a triggering event, or it may be sent periodically, or it may be sent based on both approaches. Non-limiting examples of triggering events may include an occurrence of a hardware failure in one or more cells controlled by an eNB, an occurrence of a previous hardware failure being remediated, and/or a change in cell loading (either total cell loading or load per particular type(s) of service classes).

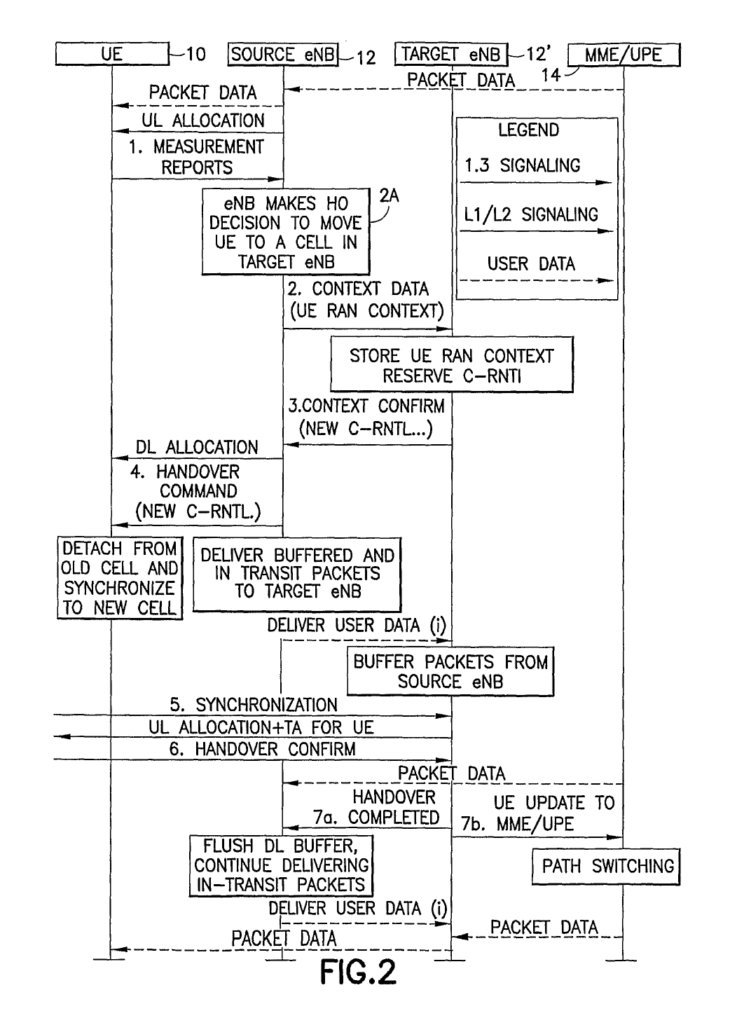

The eNB 12, 12′ which receives information that the cell under the neighboring eNB is not available, or that some feature is not supported in the cell, would consider this information when making a determination of one or more suitable candidate target eNBs (see Block 2A in FIG. 2), and in this case need not send a message to initiate a HO to that cell, or it may initiate the HO but with a request (to the UE 10) not to execute a feature or features that are not supported in that cell.

Further by example, the eNB 12, 12′ may also use the received information for RRC operations, such as removal of a cell which is reported as not available from neighboring cell information in RRC messaging to the UE 10. Further, if a cell is not in an operational mode, or is not suitable for supporting the services on-going with the UE 10, and is thus not a viable HO candidate, the cell can be removed from the neighbor cell list to prevent the UE 10 from making measurements of that cell, thereby conserving UE 10 power and also reducing unnecessary uplink signaling.

As an alternative to using the X2 interface 15 for exchanging cell-related information, the eNB 12, 12′ may report the information regarding a cell or cells under the eNB to another entity, such as an O&M (operations and maintenance) server 20, and the O&M server 20 in this case can report the information to the neighboring eNB. Note, however, that reception of a report via the O&M server 12 may have greater latency than using the X2 interface 15. Further, since the interface between the O&M server 20 and the eNB 12, 12′ is a vendor-specific interface, while the X2 15 is open interface, in a certain multi-vendor deployment one may not be able to guarantee that cell-related information reporting via the O&M server 20 is compatible.

It is also within the scope of the exemplary embodiments to use both cell-related information reporting techniques, i.e., to report some information via the X2 interface (perhaps information where a longer latency time would be a disadvantage), and to report other cell-related information (perhaps less time critical) via another agency, such as the O&M server 20 or other device.

Advantages that are realized by the use of the exemplary embodiments of this invention include, but are not limited to, reducing HO execution time, reducing the signaling load related to unsuccessful HO and/or RRC related procedures, and reducing the need of the UE 10 to measure unnecessary cells (those that are not viable HO candidates). In addition, information exchanged via the X2 interface may be used for collecting and reporting statistical information or for facilitating other O&M related procedures.

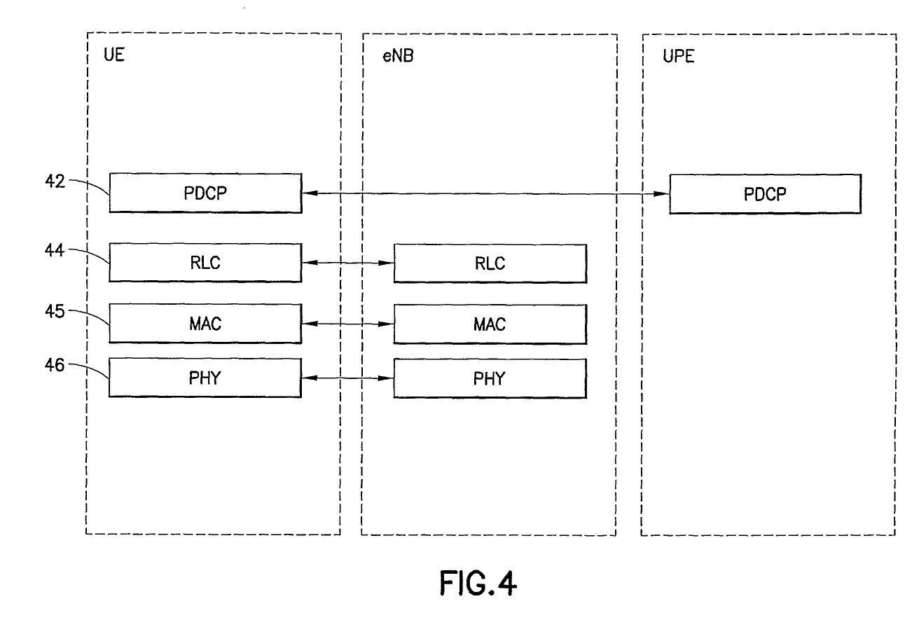

In FIG. 4, which reproduces FIG. 4.3.1 of 3GPP TS 36.300 there is illustrated the protocol stack of the user-plane. As shown in FIG. 4 there is the physical 46 sublayer and the RLC 44 and MAC 45 sublayers that can be terminated in the eNB on the network side. The user-plane protocol stack performs functions including scheduling, ARQ and HARQ. The PDCP 42 sublayer can be terminated in the UPE on the network side and can at least perform for the user plane the functions including header compression and ciphering.

The main services and functions of the MAC sublayer can include mapping between logical channels and transport channels, multiplexing and/or de-multiplexing of RLC PDUs belonging to one or different radio bearers into/from transport blocks (TB) delivered to/from the physical layer on transport channels, traffic volume measurement reporting, error correction through HARQ, priority handling between logical channels of one UE, priority handling between UEs by means of dynamic scheduling, transport format selection, mapping of Access Classes to Access Service Classes, and padding.

Further, it is noted that different kinds of data transfer services are offered with the MAC. Each logical channel type is defined by what type of information is transferred. A general classification of logical channels can be assigned into two groups being control channels for the transfer of control plane information, and traffic channels for the transfer of user plane information. In addition, the control channels can be used for transfer of control plane information. The control channels offered in the MAC include Broadcast Control Channel (BCCH) which is a downlink channel for broadcasting system control information, and Paging Control Channel (PCCH) which is a downlink channel that transfers paging information. This channel can be used when the network does not know the location cell of the UE.

In addition the main services and functions of the RLC sublayer can include transfer of upper layer PDUs supporting AM or UM, TM data transfer, error correction through ARQ where a CRC check can be provided by the physical layer such that no CRC is needed at an RLC level, segmentation according to the size of the TB, however this may be needed if an RLC SDU does not fit entirely into the TB. The segmentation process can include that the RLC SDU is segmented into variable sized RLC PDUs which may or may not include any padding.

The main services and functions of the PDCP sublayer can include header compression and decompression, transfer of user data where the transmission of user data means that the PDCP receives PDCP service data units (SDU) from the NAS and forwards them to the RLC layer, reordering of the downlink RLC SDUs at least during inter-eNB mobility, in-sequence delivery of upper layer PDUs at HO in the uplink, duplicate detection of lower layer SDUs, ciphering of user plane data and control plane data (NAS signaling), and integrity protection of control plane data (NAS signaling). It is noted that the UP and CP PDCP entities can be located in the UPE and MME, respectively. Further, it is noted that it has been submitted that the PDCP entities can also be located and/or terminated in the eNB.

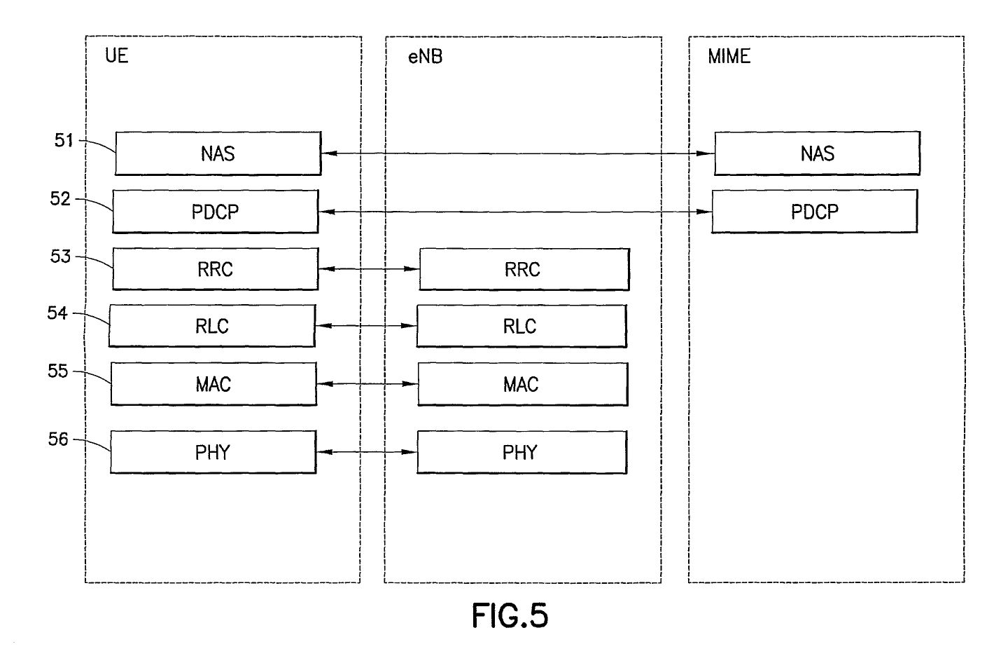

A protocol stack for a radio control-plane is illustrated in FIG. 5 which reproduces FIG. 4.3.2 of 3GPP TS 36.300. As illustrated in FIG. 5 the RRC 53 is terminated in the eNB on the network side. Further, in FIG. 5 the RLC 54 and MAC 55 sub-layers terminate in the eNB on the network side and perform functions including scheduling, ARQ, and HARQ. In addition, although not illustrated in FIG. 4 it is noted that it has been submitted that the PDCP sub-layer can also be terminated in the eNB on the network side. In addition, the PDCP sub-layer 52 performs functions for the control plane including integrity protection and ciphering. Further, the NAS control protocol 51 is terminated in the MME on the network side and includes functions of authentication and security control for signaling.

As presented in 3GPP TS 36.300 the main services and functions of the RRC 53 include, but may not be limited to, broadcast, paging, RRC connection management, RB control, mobility functions, UE measurement reporting and control broadcast of system Information related to the non-access stratum (NAS), broadcast of system information related to the access stratum (AS); establishment, maintenance and release of an RRC connection between the UE and E-UTRAN including allocation of temporary identifiers between UE and E-UTRAN, configuration of signaling radio bearer(s) for RRC connection, and low priority SRB and high priority SRB. In addition functions of the RRC include security functions such as integrity protection for RRC messages and ciphering for RRC messages; establishment, configuration, maintenance and release of point to point radio bearers; mobility functions including UE measurement reporting and control of the reporting for inter-cell and inter-RAT mobility, Inter-cell handover, UE cell selection and reselection and control of cell selection, and reselection and context transfer between eNBs; possibly notification for MBMS services; establishment, configuration, maintenance and release of radio bearer's for MBMS services; QoS management functions; UE measurement reporting and control of the reporting; MBMS control; and NAS direct message transfer to/from NAS from/to UE.

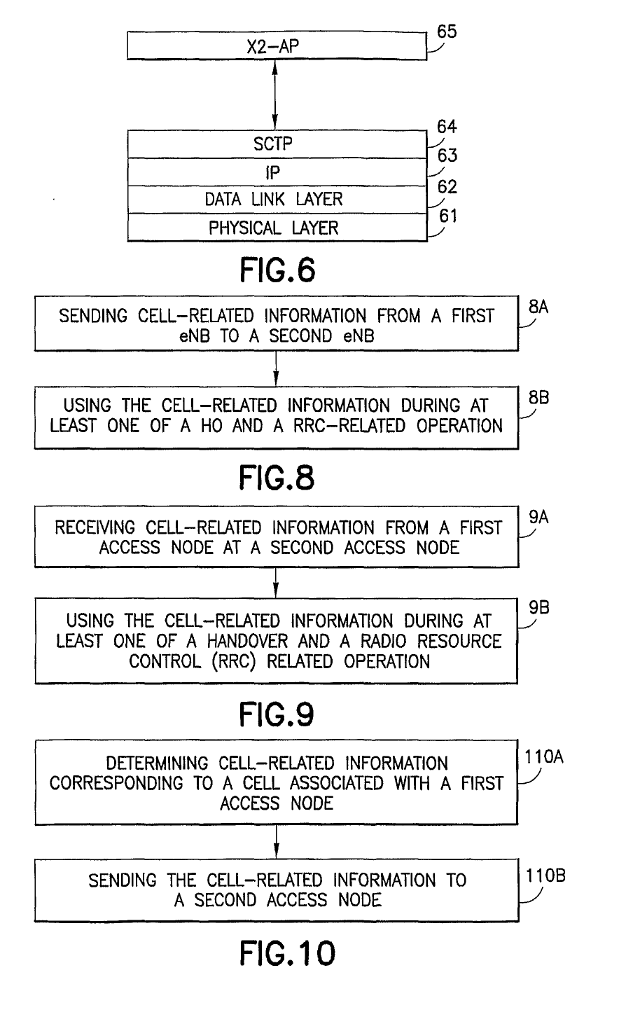

In FIG. 6 there is illustrated an X2 interface control plane protocol. FIG. 6 reproduces FIG. 20.2 of 3GPP TS 36.100 which illustrates the control plane protocol stack of the X2 interface. The X2 interface control plane (X2-CP) is defined between two neighbor eNBs. The base layers of the X2 control plane protocol stack include the data link layer 62 and the physical layer 61. The transport network layer is built on SCTP 64 on top of IP 53. The X2 application layer signaling protocol is illustrated as X2-AP 65 and is referred to as the X2 Application Protocol.

The X2 application protocol (AP) supports the functions including Intra and/or Inter LTE-Access-System mobility support for UE for context transfer from source eNB to target eNB and for control of user plane tunnels between source eNB and target eNB. The X2-AP may also support general X2 management and error handling/indication functions.

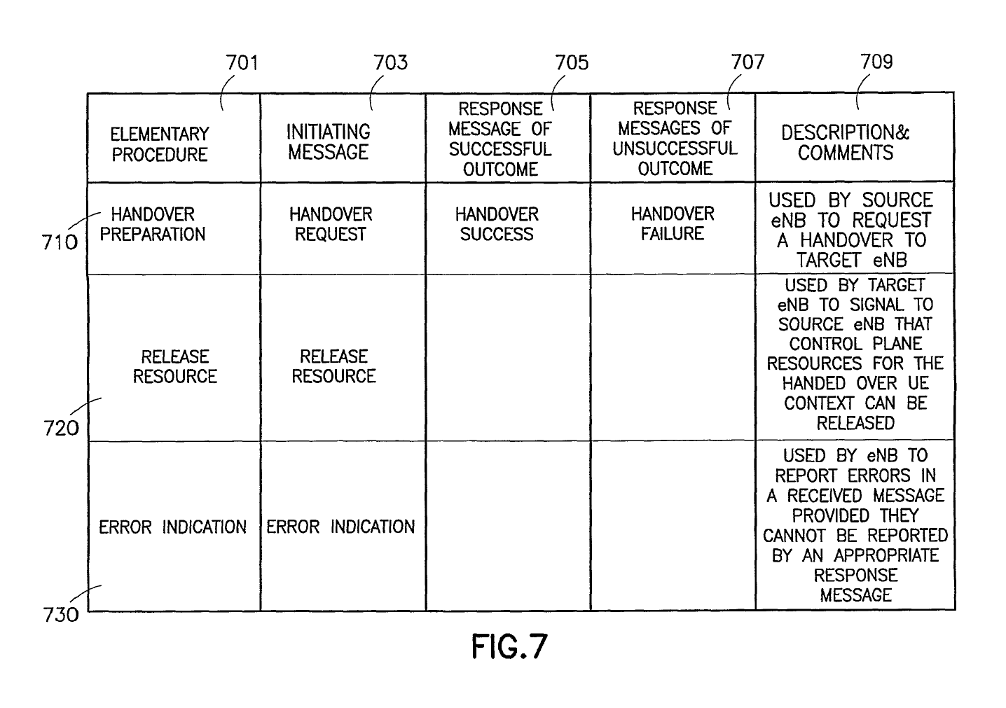

In FIG. 7 there is illustrated in table form some elementary X2 control plane procedures supported by the X2 application protocol. FIG. 7 reproduces Table 20.2.2 of 3GPP TS 36.300. In the first column elementary procedures 701 which include handover preparation 710, release resource 720, and error indication 730. Further, there are subsequent columns of associated message types pertaining to the procedures. These message types include initiating message 703, response message of successful outcome 705, and response messages of unsuccessful outcome 707. Further, in a last column there is description and comments 709. Then in correlation with these rows and columns there are messages and descriptions. In addition, it is noted that dashes are used in FIG. 7 to illustrate that the correlated row and column location may not be applicable.

Based on the foregoing it should be apparent that the exemplary embodiments of this invention include a method, apparatus, and computer program product(s) to send, as in FIG. 8, Block 8A, cell-related information from a first eNB to a second eNB; and in Block 8B to use the cell-related information during at least one of a HO and a RRC-related operation.

In addition, based on the forgoing it can also be seen that the exemplary embodiments of the invention include a method, apparatus, and computer program product(s) comprising, as in FIG. 9, receiving cell-related information from a first access node at a second access node 9A, and using the cell-related information during at least one of a handover and a radio resource control (RRC) related operation 9B.

Moreover, based on the foregoing it should be apparent that the exemplary embodiments of this invention include a method, apparatus, and computer program product(s) for, as in FIG. 10, determining cell-related information corresponding to a cell associated with a first access node 110A, and sending the cell-related information to a second access node 110B.

The method, apparatus and computer program product(s) as in the preceding paragraph, where the cell-related information is sent over an X2 interface or is sent via an external agency, such as an O&M server.

The method, apparatus and computer program product(s) as in the preceding paragraphs, where the cell-related information is used by a recipient eNB when making a determination of a target eNB for HO.

The method, apparatus and computer program product(s) as in the preceding paragraphs, where the cell-related information is used by a recipient eNB for RRC purposes.

The method, apparatus and computer program product(s) as in the preceding paragraphs, where the cell-related information is sent in response at least to at least one of an occurrence of a triggering event, or is sent periodically.

The various blocks shown in FIGS. 8, 9, and 10 may be viewed as method steps, and/or as operations that result from operation of computer program code, and/or as a plurality of coupled logic circuit elements constructed to carry out the associated function(s).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips and modules. The design of integrated circuits is by and large a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of pre-stored design modules. Once the design for a semiconductor circuit has been completed, the resultant design, in a standardized electronic format (e.g., Opus, GDSII, or the like) may be transmitted to a semiconductor fabrication facility for fabrication as one or more integrated circuit devices.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of the E-UTRAN (UTRAN-LTE) system, it should be appreciated that the exemplary embodiments of this invention are not limited for use with only this one particular type of wireless communication system, and that they may be used to advantage in other wireless communication systems.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

Further, the term “coupled” as used herein is not intended to be limited to a direct connection between recited components, but encompasses a disposition wherein there may be one or more intervening components or elements between the recited ones.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1-38. (canceled)

39. A method, comprising:
at a second access node receiving information regarding at least one of availability and capability to support one or more features of a first cell, controlled by a first access node, that is neighbor to a second cell controlled by the second access node; and
using the received information during at least one of a handover and a radio resource control (RRC) related operation, wherein the information is received periodically or as a result of a triggering event unrelated to said handover or radio resource control operation.

40. The method of claim 39, where the received information is used during a handover when making a determination of a target access node for the handover.

41. The method of claim 39, where the received information comprises information that the first cell is not available.

42. The method of claim 39, where the received information is used during the RRC-related operation and the RRC-related operation is a removal of the first cell from a cell list based on the received information.

43. The method of claim 39, where the received information comprises information that a feature is not supported by the first cell and where the received information is used to initiate a handover to the first cell with a request not to execute the feature not supported.

44. The method of claim 39, where the second access node considers the received information when making a determination of a suitable target cell for a handover.

45. The method of claim 39 embodied in a program stored on a computer readable medium and executable by a processor.

46. An apparatus, comprising:
an interface; and
a processor;
the interface configured to receive information regarding at least one of availability and capability to support one or more features of a first cell, controlled by a first access node, that is neighbor to a second cell controlled by the apparatus; and
the processor coupled to the interface and configurable to use the received information during at least one of a handover and a radio resource control (RRC) related operation, wherein the information is received periodically or as a result of a triggering event unrelated to said handover or radio resource control operation.

47. The apparatus of claim 46, where the interface comprises an X2 interface.

48. The apparatus of claim 46 embodied in an EUTRAN Node B (eNB).

49. The apparatus of claim 46, where the information is received via an external agency.

50. The apparatus of claim 46, where the received information is used during a handover when making a determination of a target access node for a handover.

51. The apparatus of claim 46, where the information comprises information that the first cell is not available.

52. The apparatus of claim 46, where the received information is used during the RRC-related operation and the RRC-related operation is a removal of the first cell from a cell list based on the received information.

53. The apparatus of claim 46, where the received information comprises information that a feature is not supported by the first cell and where the information is used to initiate a handover to the first cell with a request not to execute the feature not supported.

54. The apparatus of claim 46, where the received information is considered when making a determination of a suitable target cell for a handover.

55. The apparatus of claim 46, where the received information is used in place of sending a message to initiate a handover to a suitable target cell.

56. A method, comprising:
determining information corresponding to a first cell associated with a first access node, where the information is regarding at least one of availability and capability to support one or more features of the first cell, controlled by the first access node, that is neighbor to a second cell controlled by a second access node; and
sending the information to the second access node, wherein the information is sent periodically or as a result of a triggering event unrelated to a handover or radio resource control operation.

57. The method of claim 56, where the triggering event includes a hardware failure in one or more cells.

58. The method of claim 56, where the triggering event includes a remediation of a previous hardware failure in one or more cells.
